(19) United States
(12) Patent Application Publication
(10) Pub. No.: US 2008/0034588 A1
(43) Pub. Date: Feb. 14, 2008

(54) Jewelry manufacturing device

(76) Inventor: Thuc Van Nguyen, Dorchester, MA (US)

Correspondence Address: LAMBERT & ASSOCIATES, P.L.L.C., 92 STATE STREET, BOSTON, MA, 02109-2004, US

(21) Appl. No.: 11/497,985

(22) Filed: Aug. 2, 2006

(51) Int. Cl. B23P 19/00; A44C 27/00

(52) U.S. Cl. 29/896.4; 29/700

(57) ABSTRACT

A device for manufacturing jewelry, utilizing a conversion of rotary to reciprocating motion and realizing a reciprocating tool, which acts as a hammer, comprising a constant force output. A reciprocating piston mechanism, in conjunction with a control element, allows the user to properly prepare and set stones, with out use of cumbersome mounting machines or hand punches tools, which fail to provide a constant output.

### BACKGROUND OF THE INVENTION

1. Field of Invention

The invention relates generally to the field of jewelry manufacture and especially regarding tools for setting of jewels and stones within rings, necklaces, broaches, bracelets and the like.

2. Description of the Related Art

The use of tools to secure stones in place or set the stones is known in the art. More specifically, stone setting/presetting tools heretofore devised and utilized are known to consist basically of familiar, expected and obvious structural configurations, such as hard mounted machinery or simplistic hand held, non-power tools which require much hand work and patience.

While the prior art devices, including hard mounted and non-powered hand manipulated tools, none disclose the novel features, including flexibility and control of setting illustrating in the instant invention.

### BRIEF SUMMARY OF THE INVENTION

The present invention, as described further herein imparts a novel jewelry priming and setting tool which encompasses the advantages of prior art hard mounted drilling, machining or milling machines and hand held non-powered, stone setting tools. The hand held apparatus, which acts as a pummel featuring controlled reciprocation as illustrated herein, is clearly not anticipated, rendered obvious, or even present in any of the prior art mechanisms, either alone or in any combination thereof.

The present invention can include a hard mounted or portable prime mover, such as a motor or other form of rotary generator, in communication with a power transmission device which converts rotary to reciprocating motion.

It is an object of the present invention to provide a high speed, reciprocating mechanism for precision jewelry manufacture which is housed in an ergonomic, hand held cylindrical chassis or member.

Additionally, it is an object of the present invention to provide a jewelry setting and preparation tool that requires no set up time as the tool is portable and hand held and thus can be brought to the work piece.

Unlike prior mounted drilling and hole priming devices, it is an object of the present device to allow the user to alter the angle of contact.

Moreover contrary to prior hand held devices, the instant device bestows upon the user the ability to maintain a constant force coefficient while spreading the prongs, priming the work piece, and setting the prongs with the jewel in place, since every stroke of the reciprocating mechanism possesses a constant displacement and the spring control mechanism ensures that the stone will not be damaged. Thus, the instant invention combines the paramount features of both non powered hand held and table mounted machines shown in the industry.

These together with other objects of the invention, along with the various features of novelty which characterize the invention, are pointed out with particularity in the claims annexed to and forming a part of this disclosure. The invention is not limited to the embodiments described herein, thus reference should be made to the accompanying drawings and descriptive matter in which the preferred embodiments of the invention are illustrated.

### BRIEF DESCRIPTION OF THE SEVERAL VIEWS OF THE DRAWINGS

FIG. 1 is a schematic diagram illustrating the principles of the present invention.

FIG. 2 is a side view of the outer portion of the power transmission device illustrating the outer the external port for the rotary power source, the shaft and the outer connection to the reciprocating tool.

FIG. 3 is a side view of the outer portion of the power transmission device illustrating the rotary power source entering the external connection.

FIG. 4 illustrates the outer portion of the power transmission device and particularly illustrates idler gear number one and idler gear number two.

FIG. 5 is a side cross sectional view of the power transmission device illustrating the inner portion of the transmission and in particular the gearing which transfers rotating to reciprocating motion.

FIG. 6 is a cross sectional view of the reach rod, piston and buffering spring mechanisms.

FIG. 7 is a side isometric view of the outer portion of the power transmission device illustrating the outer the external port for the rotary power source, the shaft and the outer connection to the reciprocating tool.

FIG. 8 is an isometric view of the reach rod, piston and control device mechanisms.

### DETAILED DESCRIPTION OF THE INVENTION

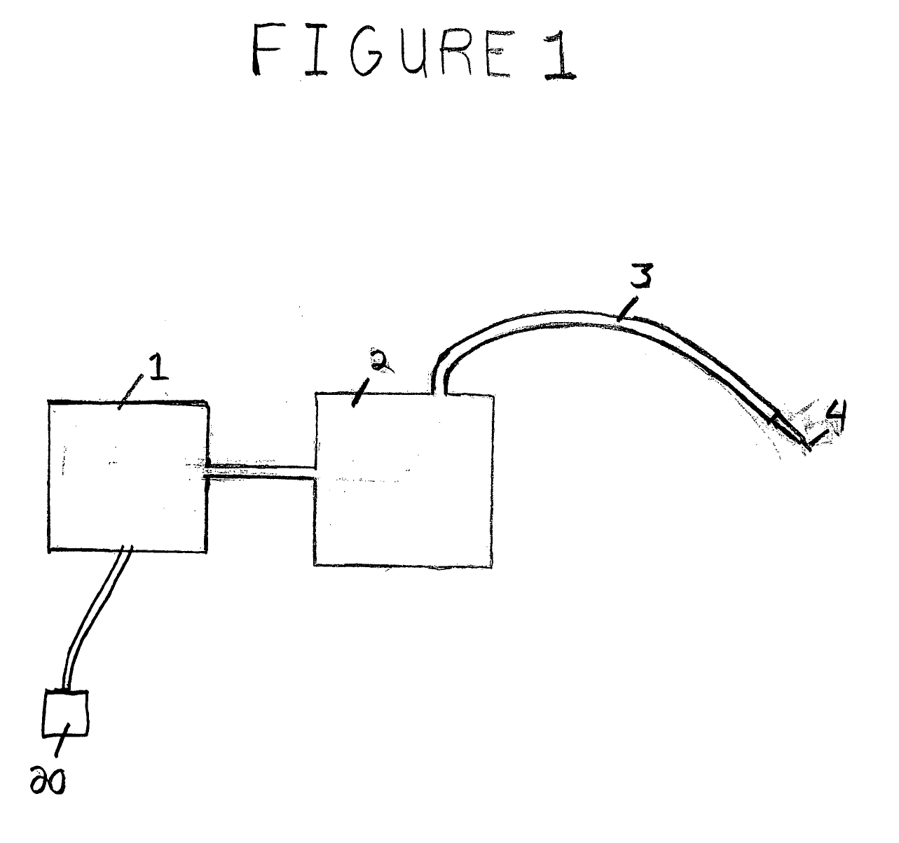

As illustrated in FIGS. 1, the system converts the rotary power generated from a motor 1 to reciprocating power source 2 through utilization of transmission 3 and transfer the power to a reciprocating tool 4 in order to maximize efficiency in manufacturing of jewelry.

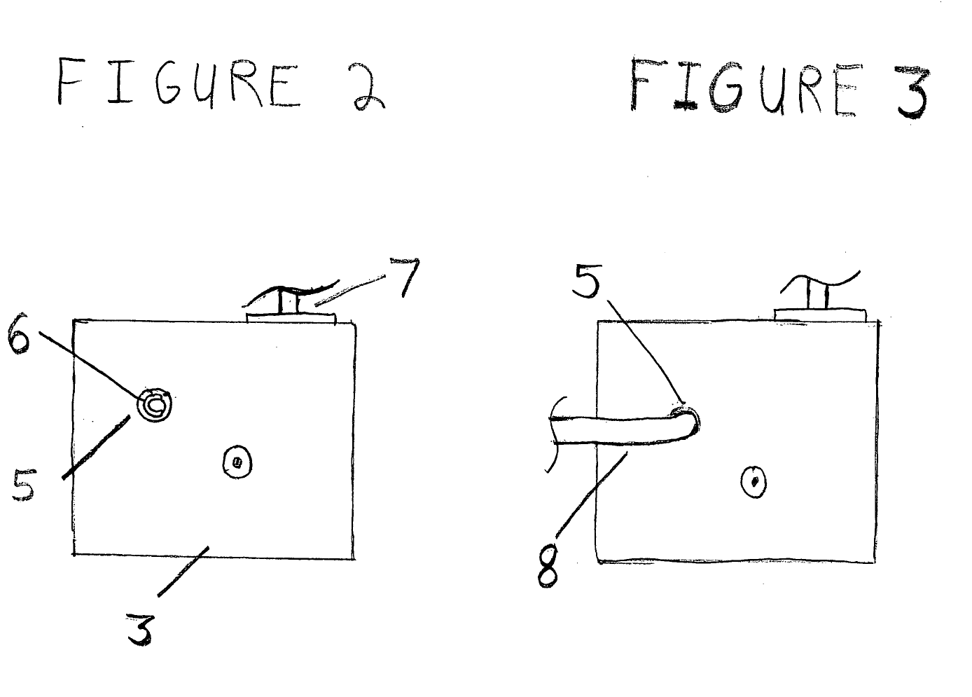

FIG. 2 illustrates the outer portion of the power transmission device and particularly illustrates the external port for the rotary power source 5, the shaft 6, where the rotary source connects and the outer connection to the reciprocating tool 7. Further, FIG. 3 illustrates the outer portion of the power transmission device and particularly illustrates the rotary power source 8 entering the external port 5, for coupling to the shaft 6.

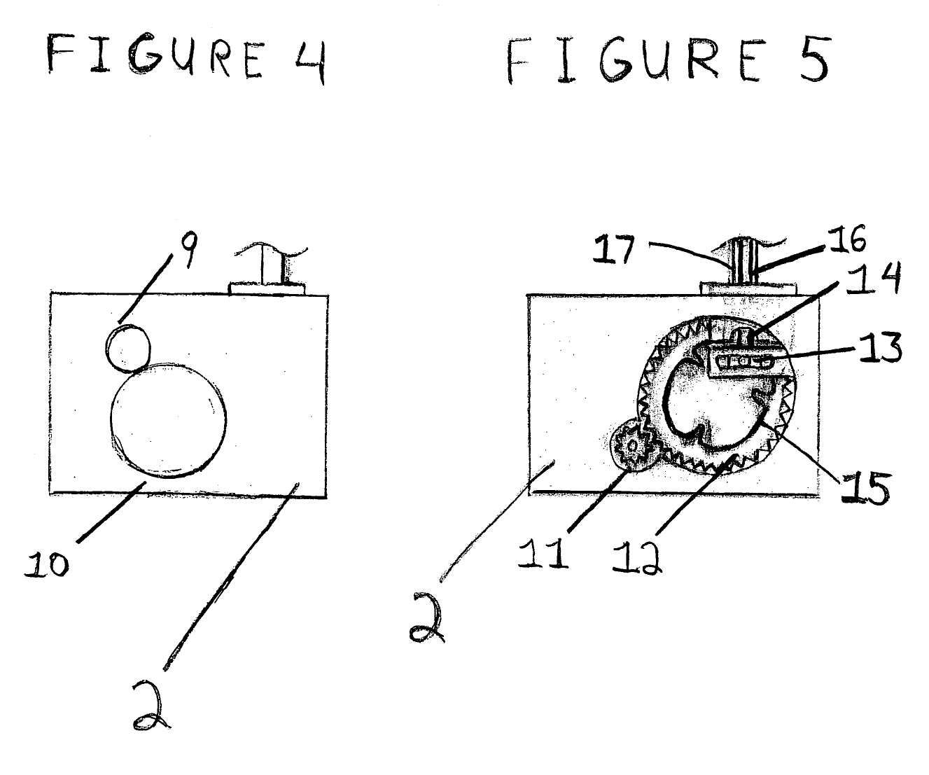

FIG. 4 illustrates the opposing outer portion of the power transmission device and particularly illustrates idler gear one 9 and idler gear two 10. The shaft 6 (as shows in FIG. 2) transfers the rotary power to idler gear one 9 and idler gear one 9 transfers rotary power to two 10. FIG. 5 and 8 illustrate the inner portion of the power transmission device and in particular the drive gear 11 cam gear 12 which transfers rotating to reciprocating motion. Further illustrated are the follower mechanism 13 and the pin 14. As the follower mechanism 13 rides along the internal surface 15 of the cam gear and reaches the high points in the internal surface 15, it contacts the pin 14. The pin 14 in turn internally contacts the reach rod 16, which is housed within the external covering 17.

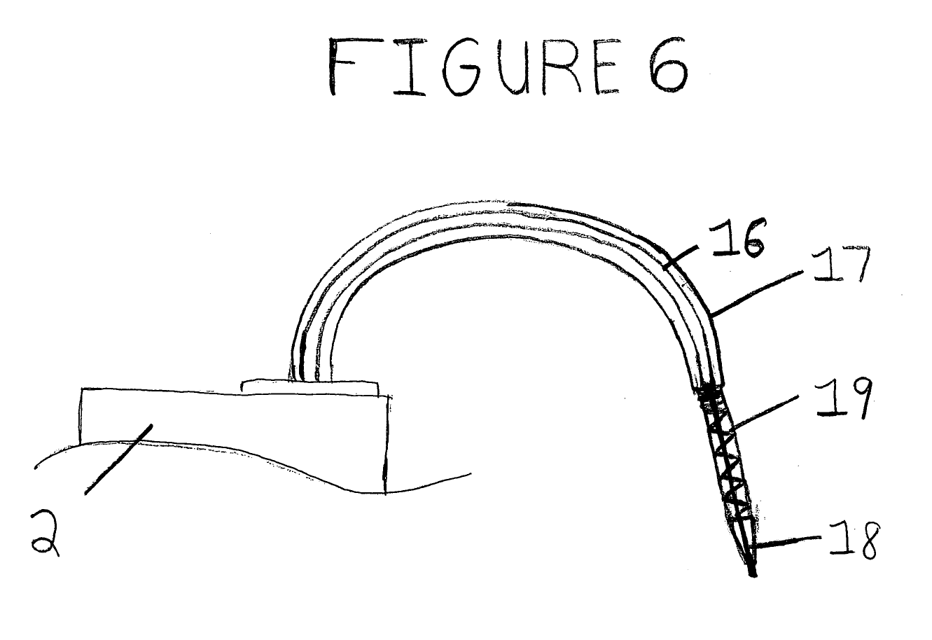

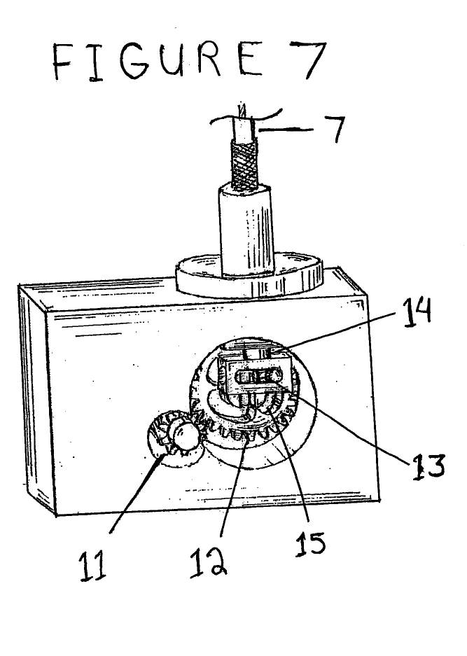

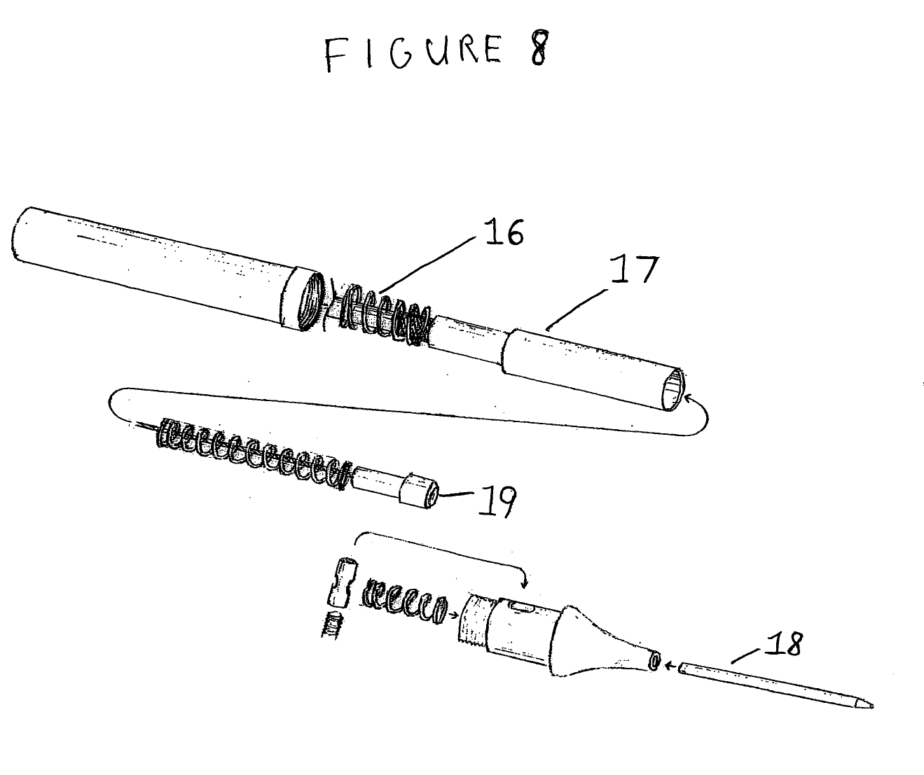

Finally, FIG. 6 and 8 illustrate the reach rod 16, piston 18 or hammer and control device 19 mechanisms. The control device 19 can be a spring or other damping mechanism. The piston 18 makes direct contact with the work piece and is buffered by the control device 19. The remote actuating device 20 for the motor is shown in FIG. 1. This device can be a foot pedal or other device such that the hands of the user are free to control the apparatus and the work piece.

Unlike mounted drilling and hole priming device, the instant device allows the user to alter the angle of contact. Further, no need to remove material through drilling, thus getting a custom fit as the stone can be placed for testing and removed and further boring of the piece can be executed until a perfect fit can be achieved.

Moreover pleasantly contrary to prior hand held devices, the instant device bestows upon the user the ability to maintain a constant force coefficient while priming the work piece, preparing the prongs or setting the prongs with the jewel in place since every stroke of the reciprocating mechanism possesses a constant displacement. The work piece can now be hand held or mounted in any position with no constraints.

In one embodiment, the jewelry manufacture apparatus may comprise a rotary generation mechanism in communication with a remote operating apparatus and also in communication with a power transmission or conversion device, which converts rotary to reciprocating motion. Additionally, the remote operating apparatus may include as a foot pedal or other hand held or non-hand held triggering mechanism utilized to actuate the motor. Further the power transmission device is in communication with a reciprocating tool, which is encased within a cylindrical housing.

The power transmission device may comprise a set of gears in communication with a cam and a follower in communication with a pin. The pin is thus in communication with a reach rod which communicates with the reciprocating tool to induce reciprocating motion in the tool. The reach rod may comprise an encased wire rope comprising individual wrapped wire strands. The reciprocating tool, which acts as a hammer, may be spring loaded and should include an opposing force member to regulate the magnitude of the force imparted upon the work piece. Thus, the distance traveled by the reciprocating tool and the magnitude of the force generated by each stroke of said reciprocating tool should be identical. Additionally the jewelry manufacture apparatus may be of a portable, hand held design or of a table mounted design.

In a further embodiment, a stone setting device may comprising a motor, a motor actuation mechanism, which may be remote, a mechanism for transferring rotary power, a power conversion mechanism, a mechanism for transferring reciprocating power, and piston mechanism including an opposing force to regulate said piston. The opposing force may comprise a spring or other such mechanism.

In a further embodiment, a method for manufacturing jewelry may be utilized comprising priming a work piece stone receiving area with a reciprocating tool, spreading the prongs for receipt of the jewel, positioning the jewel and setting the prongs around said jewel with a constant force, reciprocating device.

In sum, the instant device allows the craftsman to perform functions of drilling, carving, engraving, bead raising, bright cutting, bezel/prongs closing, stone setting, and texturing with maximum accuracy and precision. The hand piece or handle has the built in spring mechanism, which eliminates the shaking and vibration while allowing an even, constant adjustable striking force each and every time.

Further, the device is compact (can fit in a lunch or tote bag), portable, does not require an air compressor, does not require changing of hand piece handles for a different tool each time, and finally accommodates most hand piece attachments available on the market.

I claim:

1. A jewelry manufacture apparatus comprising:
a rotary generation mechanism;
said rotary generation mechanism in communication with a power transmission device;
said power transmission device in communication a reciprocating tool;
said reciprocating tool encased within a cylindrical housing;
said rotary generation mechanism in communication with a remote operating apparatus.

2. The jewelry manufacture apparatus of claim 1 wherein said power transmission device converts rotary to reciprocating motion.

3. The jewelry manufacture apparatus of claim 1 wherein said power transmission device comprises a set of gears in communication with a cam and a follower.

4. The jewelry manufacture apparatus of claim 3 wherein said follower is in communication with a pin.

5. The jewelry manufacture apparatus of claim 4 wherein said pin is in communication with a reach rod.

6. The jewelry manufacture apparatus of claim 5 wherein reach rod is in communication with said reciprocating tool.

7. The jewelry manufacture apparatus of claim 5 wherein said reach rod comprises an encased wire rope.

8. The jewelry manufacture apparatus of claim 7 wherein said encased wire rope comprises wrapped individual wire strands.

9. The jewelry manufacture apparatus of claim 1 wherein said remote operating apparatus comprises a foot pedal.

10. The jewelry manufacture apparatus of claim 1 wherein said the motion of said reciprocating tool is regulated by an opposing force member.

11. The jewelry manufacture apparatus of claim 1 wherein said opposing force member is a spring.

12. The jewelry manufacture apparatus of claim 1 wherein the distance traveled in each stroke of said reciprocating tool is identical.

13. The jewelry manufacture apparatus of claim 1 wherein said force generated by each stroke of said reciprocating tool is identical in magnitude.

14. The jewelry manufacture apparatus of claim 1 wherein said jewelry manufacture apparatus is portable.

15. The jewelry manufacture apparatus of claim 1 wherein said reciprocating tool is hand held.

16. A stone setting device comprising:
a motor;
a motor actuation mechanism;
a mechanism for transferring rotary power;
a power conversion mechanism;
a mechanism for transferring reciprocating power; and
an hammer mechanism comprising an opposing force mechanism.

17. The stone setting apparatus of claim 16 wherein said motor actuation mechanism is remote.

18. The stone setting apparatus of claim 16 wherein said opposing force mechanism is spring loaded.

19. The stone setting apparatus of claim 16 wherein said stone setting apparatus is portable.

20. A method for manufacturing jewelry comprising:
priming a work piece stone receiving area with a reciprocating tool;
spreading the prongs for receipt;
positioning a jewel;
setting said prongs around said jewel with a constant force, reciprocating device.
